(19) United States
(12) Patent Application Publication
(10) Pub. No.: US 2007/0207397 A1
(43) Pub. Date: Sep. 6, 2007

(54) Toner compositions

(75) Inventor: Paul Julien, Webster, NY (US)

Correspondence Address: Carter, DeLuca, Farrell & Schmidt, LLP, Suite 225, 445 Broad Hollow Road, Melville, NY, 11747, US

(73) Assignee: Xerox Corporation

(21) Appl. No.: 11/367,513

(22) Filed: Mar. 3, 2006

(51) Int. Cl. G03G 9/09

(52) U.S. Cl. 430/107.1; 430/137.1; 430/45.51

(57) ABSTRACT

A process for the preparation of a combination of color toners is provided wherein the particle size of toner utilized with each color is tailored to optimize pigment loading and mass per unit area on the toner.

### BACKGROUND

The present disclosure relates generally to toners and toner processes, and more specifically, to toner compositions having sizes tailored to the pigment(s) utilized therewith.

In electrophotography, an image is produced by forming an electrostatic latent image on a surface of a photoreceptor having a drum or belt shape, or the like, developing the electrostatic latent image with a toner so as to obtain a toner image, electrostatically transferring the toner image onto a recording media such as paper directly or via an intermediate transfer member, and fusing the toner onto a surface of the recording paper by heating, or the like.

Numerous processes are known for the preparation of toners, such as, for example, conventional processes wherein a resin is melt kneaded or extruded with a pigment, micronized and pulverized to provide toner particles. There are illustrated in U.S. Pat. Nos. 5,364,729 and 5,403,693, the disclosures of each of which are hereby incorporated by reference in their entirety, methods of preparing toner particles by blending together latexes with pigment particles. Also relevant are U.S. Pat. Nos. 4,996,127, 4,797,339 and 4,983,488, the disclosures of each of which are hereby incorporated by reference in their entirety.

Toner can also be produced by emulsion aggregation methods. Methods of preparing an emulsion aggregation (EA) type toner are known and toners may be formed by aggregating a colorant with a latex polymer formed by emulsion polymerization. For example, U.S. Pat. No. 5,853,943, the disclosures of which is hereby incorporated by reference in its entirety, is directed to a semi-continuous emulsion polymerization process for preparing a latex by first forming a seed polymer. In particular, the '943 patent describes a process including: (i) conducting a pre-reaction monomer emulsification which includes emulsification of the polymerization reagents of monomers, chain transfer agent, a disulfonate surfactant or surfactants, and optionally, but in embodiments, an initiator, wherein the emulsification is accomplished at a low temperature of, for example, from about 5° C. to about 40° C.; (ii) preparing a seed particle latex by aqueous emulsion polymerization of a mixture including (a) part of the monomer emulsion, from about 0.5 to about 50 percent by weight, or from about 3 to about 25 percent by weight, of the monomer emulsion prepared in (i), and (b) a free radical Initiator, from about 0.5 to about 100 percent by weight, or from about 3 to about 100 percent by weight, of the total initiator used to prepare the latex polymer at a temperature of from about 35° C. to about 125° C., wherein the reaction of the free radical initiator and monomer produces the seed latex comprised of latex resin wherein the particles are stabilized by surfactants; (iii) heating and feed adding to the formed seed particles the remaining monomer emulsion, from about 50 to about 99.5 percent by weight, or from about 75 to about 97 percent by weight, of the monomer emulsion prepared In (ii), and optionally a free radical initiator, from about 0 to about 99.5 percent by weight, or from about 0 to about 97 percent by weight, of the total Initiator used to prepare the latex polymer at a temperature from about 35° C. to about 125° C.; and (iv) retaining the above contents in the reactor at a temperature of from about 35° C. to about 125° C. for an effective time period to form the latex polymer, for example from about 0.5 to about 8 hours, or from about 1.5 to about 6 hours, followed by cooling. Other examples of emulsion/aggregation/coalescing processes for the preparation of toners are illustrated in U.S. Pat. Nos. 5,290,654, 5,278,020, 5,308,734, 5,370,963, 5,344,738, 5,403,693, 5,418,108, 5,364,729, and 5,346,797, the disclosures of each of which are hereby incorporated by reference in their entirety. Other processes are disclosed in U.S. Pat. Nos. 5,348,832, 5,405,728, 5,366,841, 5,496,676, 5,527,658, 5,585,215, 5,650,255, 5,650,256 and 5,501,935, the disclosures of each of which are hereby incorporated by reference in their entirety.

Color toners are also within the purview of those skilled in the art. In U.S. Pat. Nos. 5,556,727, 5,591,552, 5,554,471, 5,607,804, and 5,620,820, the disclosures of each of which are hereby incorporated by reference in their entirety, there is illustrated a combination of four color toners for the development of electrostatic latent images enabling the formation of a full color gamut image, wherein the four toners include a cyan toner, a magenta toner, a yellow toner, and a black toner. Each of these toners include a resin and pigment, wherein the pigment for the cyan toner is a β-copper phthalocyanine, the pigment for the magenta toner is a xanthene silicomolybdic acid salt of RHODAMINE 6G basic dye, the pigment for the yellow toner is a diazo benzidine, and the pigment for the black toner is carbon black.

In U.S. Pat. No. 5,688,626, the disclosure of which is hereby incorporated by reference in its entirety, a gamut toner aggregation process is disclosed including a process for the preparation of a combination of color toners including a cyan toner, a magenta toner, a yellow toner, and a black toner. Each of these toners include a resin and pigment, wherein the pigment is cyan, magenta, yellow and black, and each of the pigments are dispersed in a nonionic, or neutral charge surfactant. In addition, each toner in the combination is prepared by (i) preparing a pigment dispersion, which dispersion includes a pigment and nonionic water soluble surfactant; (ii) shearing the pigment dispersion with a latex or emulsion blend including a resin, a counterionic surfactant with a charge polarity of opposite sign to that of the ionic surfactant, and a nonionic surfactant; (iii) heating the above sheared blend below about the glass transition temperature (Tg) of the resin to form electrostatically bound toner size aggregates; and (iv) heating the bound toner size aggregates above about the Tg of the resin.

For color toner development, a certain pigment mass per unit area may be necessary to achieve the desired color strength, with the toner polymer acting as a binder. The cost of such toner will include the cost associated with the work and materials that go into making the toner on a weight basis. The most cost effective toner is thus one that minimizes the amount of polymer and other ingredients, while retaining the same pigment mass per unit area. In practice, this means utilizing toners with smaller particle sizes and higher pigment loadings.

The processing and ability to control the properties of the toners may become more difficult at smaller sizes and higher pigment loadings, but not equally for each pigment. Typically one pigment is more difficult to work with because the loadings required at smaller sizes lead to more processing or control difficulties than the others. Because machines are typically designed so that all the color toners have the same size and are developed to the same mass per unit area, this one toner can thus limit the size of all the toners.

Toner particles of the same size are often used for cyan, magenta, and yellow colors to obtain the same mass targets in color printers. Some printers may have different targets for cyan, magenta, and yellow due to image on image considerations even though the particle sizes are the same, so color balance is possible with different developed mass per unit area (DMA) targets. However, for colored toners, the most desirable toner particle size in terms of cost effectiveness and processability to obtain a target pigment mass per unit area (PMA) will differ from color to color. Thus, depending upon the toner formulation and the pigments utilized in forming such color toners, for at least one color, it may be more difficult to decrease particle size of the toner while increasing pigment loading for that toner. The cost to produce a conventional toner may thus be determined by the cost associated with the pigment that is most difficult in being combined with smaller size toner and achieving higher pigment loadings.

Improved methods for producing toner, which have desirable PMA targets and reduced costs and are capable of utilizing existing processing equipment and machinery, remain desirable.

### SUMMARY

The present disclosure provides compositions having a first toner including a first resin in combination with a first colorant and a second toner including a second resin in combination with a second colorant, wherein the first colorant and the second colorant are different and are not carbon black and wherein particles comprising the first toner differ in volume average diameter from particles comprising the second toner by from about 10% to about 50% in size.

Suitable resins utilized to make the toners include styrenes, acrylates, methacrylates, butadienes, isoprenes, acrylic acids, methacrylic acids, acrylonitriles, and mixtures thereof, and suitable colorants include pigments, dyes, mixtures of pigments and dyes, mixtures of pigments, and mixtures of dyes.

In embodiments toners may be optionally combined with one or more components such as surfactants, coagulants, waxes, surface additives, and optionally mixtures thereof.

In embodiments, the compositions may include additional toners including additional resins in combination with additional colorants.

In embodiments, the toners may be produced by emulsion aggregation methods.

The present disclosure also provides a composition including a cyan toner comprising a first resin in combination with a first colorant, a magenta toner including a second resin in combination with a second colorant, a yellow toner including a third resin in combination with a third colorant, and a carbon black toner including a fourth resin in combination with a fourth colorant, wherein particles of one of the cyan, magenta, or yellow toners differ in volume average diameter from particles of the other toners not including carbon black by from about 10% to about 50% in size.

Methods for making these compositions are also provided wherein a first resin is contacted with a first colorant to form a first toner, a second resin is contacted with a second colorant to form a second toner, and the first toner is contacted with the second toner to form a color toner, wherein the first colorant and the second colorant are different and are not carbon black and wherein particles including the first toner differ in volume average diameter from particles including the second toner by from about 10% to about 50%.

### DETAILED DESCRIPTION

In accordance with the present disclosure, toner compositions are provided which include toner particles of varying sizes in combination with different pigments or dyes. The particle size of the toner utilized with each color may be tailored in size to obtain the most efficient development characteristics of the resulting toner; thus, differing particle sizes may be utilized for the various colors of the toner resulting in differing target masses for each toner for development.

In accordance with the present disclosure, processes and toners are provided whereby colored toners may be combined to produce well balanced color output. Suitable color toners include cyan, yellow, magenta, red, orange, brown, green, blue, violet and combinations thereof. In accordance with the present disclosure, the toner utilized with at least one colorant has a different particle size compared with toners utilized with the other colorants. In embodiments, at least one may be from about one to about twenty and, in embodiments, from about two to about ten. The difference in particle size of at least one of the color toners compared with the others may be, in embodiments, from about 10% to about 50% difference in particle size, in embodiments from about 15% to about 25% difference in particle size.

Toners of the present disclosure may include a latex in combination with a pigment. While the latex may be prepared by any method within the purview of one skilled in the art, in embodiments the latex may be prepared by emulsion polymerization methods and the toner may include emulsion aggregation toners. Emulsion aggregation involves aggregation of both submicron latex and pigment particles into toner size particles, where the growth in particle size is, for example, from submicron to about 3 microns to about 10 microns. Pigments added to such toner particles thus are generally combined with the same toner size. However, as the pigments utilized may not be uniform in size, it may be easier to obtain higher loadings with some pigments having a smaller size.

Illustrative examples of specific latex resins, polymer or polymers that can be utilized in accordance with the present disclosure include styrene acrylates, styrene butadienes, styrene methacrylates, and more specifically, poly(styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylateisoprene), poly(methyl acrylate-isoprene), poly(ethyl acrylate-isoprene), poly(propyl acrylate-isoprene), poly(butyl acrylate-isoprene), poly(styrene-butylacrylate), poly(styrene-butadiene), poly(styrene-isoprene), poly(styrene-butyl methacrylate), poly(styrene-butyl acrylate-acrylic acid), poly(styrene-butadiene-acrylic acid), poly(styrene-isoprene-acrylic acid), poly(styrene-butyl methacrylate-acrylic acid), poly(butyl methacrylate-butyl acrylate), poly(butyl methacrylate-acrylic acid), poly(styrene-butyl acrylate-acrylonitrile-acrylic acid), and poly(acrylonitrile-butyl acrylate-acrylic acid). In addition, polyester resins obtained from the reaction of bisphenol A and propylene oxide or propylene carbonate, and in particular including such polyesters followed by the reaction of the resulting product with fumaric acid (as disclosed in U.S. Pat. No. 5,227,460, the entire disclosure of which is incorporated herein by reference), and branched polyester resins resulting from the reaction of dimethylterephthalate with 1,3-butanediol, 1,2-propanediol, and pentaerythritol may also be used.

In embodiments, a poly(styrene-butyl acrylate) may be utilized as the latex.

In embodiments, the latex may be prepared in an aqueous phase containing a surfactant or co-surfactant. Surfactants which may be utilized in the latex dispersion can be ionic or nonionic surfactants in an amount of from about 0.01 to about 15, and in embodiments of from about 0.01 to about 5 weight percent of the solids.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abietic acid available from Aldrich, NEOGEN R™, NEOGEN SC™ obtained from Daiichi Kogyo Seiyaku Co., Ltd., mixtures thereof, and the like.

Examples of cationic surfactants include, but are not limited to, ammoniums, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, and C12, C15, C17 trimethyl ammonium bromides, mixtures thereof, and the like. Other cationic surfactants include cetyl pyridinium bromide, halide salts of quaternized polyoxyethylalkylamines, dodecylbenzyl triethyl ammonium chloride, MIRAPOL and ALKAQUAT available from Alkaril Chemical Company, SANISOL (benzalkonium chloride), available from Kao Chemicals, and the like, and mixtures thereof. In embodiments a suitable cationic surfactant includes SANISOL B-50 available from Kao Corp., which is primarily a benzyl dimethyl alkonium chloride.

Examples of nonionic surfactants include, but are not limited to alcohols, acids and ethers, for example, polyvinyl alcohol, polyacrylic acid, methalose, methyl cellulose, ethyl cellulose, propyl cellulose, hydroxyl ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, mixtures thereof, and the like. In embodiments commercially available surfactants from Rhone-Poulenc such as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™ can be selected.

The choice of particular surfactants or combinations thereof as well as the amounts of each to be used are within the purview of those skilled in the art.

In embodiments initiators may be added for formation of the latex. Examples of initiators include water soluble initiators, such as ammonium persulfate, sodium persulfate and potassium persulfates, and organic soluble initiators including organic peroxides and azo compounds including Vazo peroxides, such as VAZO 64™, 2-methyl 2-2′-azobis propanenitrile, VAZO 88™, and 2-2′-azobis isobutyramide dehydrate and mixtures thereof. Initiators can be added in suitable amounts, such as from about 0.1 to about 8 weight percent, and in embodiments of from about 0.2 to about 5 weight percent of the monomers.

In embodiments chain transfer agents may be utilized including dodecane thiol, octane thiol, carbon tetrabromide, mixtures thereof, and the like, in amounts from about 0.1 to about 10 percent and, in embodiments, from about 0.2 to about 5 percent by weight of monomers, to control the molecular weight properties of the polymer when emulsion polymerization is conducted in accordance with the present disclosure.

In some embodiments a pH titration agent may be added to control the rate of the emulsion aggregation process. The pH titration agent utilized in the processes of the present disclosure can be any acid or base that does not adversely affect the products being produced. Suitable bases can include metal hydroxides, such as sodium hydroxide, potassium hydroxide, ammonium hydroxide, and optionally mixtures thereof. Suitable acids include nitric acid, sulfuric acid, hydrochloric acid, citric acid, acetic acid, and optionally mixtures thereof.

In the emulsion aggregation process, the reactants may be added to a suitable reactor, such as a mixing vessel. The appropriate amount of at least two monomers, stabilizer, surfactant(s), initiator, if any, chain transfer agent, if any, and wax, if any, and the like may be combined in the reactor and the emulsion aggregation process is allowed to begin. Reaction conditions selected for effecting the emulsion polymerization include temperatures ranging, for example, from about 45° C. to about 120° C., in embodiments about 60° C. to about 90° C. In embodiments the polymerization may occur at elevated temperatures within 10 percent of the melting point of any wax, for example from about 60° C. to about 85° C., in embodiments from about 65° C. to about 80° C. to permit the wax to soften thereby promoting dispersion and incorporation into the emulsion.

Nanometer size particles may be formed, from about 50 nm to about 800 nm in volume average diameter, in embodiments from about 100 nm to about 400 nm in volume average diameter as determined, for example, by a Brookhaven nanosize particle analyzer.

After formation of the latex particles, the latex particles may be utilized to form a toner. In embodiments, the toners are an emulsion aggregation type toner that are prepared by the aggregation and fusion of the latex particles of the present disclosure with a colorant, and one or more additives such as surfactants, coagulants, waxes, surface additives, and optionally mixtures thereof.

The latex particles may be added to a colorant dispersion. The colorant dispersion includes, for example, submicron colorant particles in a size range of, for example, from about 50 to about 500 nanometers and, in embodiments, of from about 100 to about 400 nanometers in volume average diameter. The colorant particles may be suspended in an aqueous water phase containing an anionic surfactant, a nonionic surfactant, or mixtures thereof. In embodiments, the surfactant may be ionic and is from about 1 to about 25 percent by weight, and in embodiments from about 4 to about 15 percent by weight of the colorant.

Colorants useful in forming toners in accordance with the present disclosure include pigments, dyes, mixtures of pigments and dyes, mixtures of pigments, mixtures of dyes, and the like. The colorant may be, for example, carbon black, cyan, yellow, magenta, red, orange, brown, green, blue, violet or mixtures thereof.

In embodiments wherein the colorant is a pigment, the pigment may be, for example, carbon black, phthalocyanines, quinacridones or RHODAMINE B™ type, red, green, orange, brown, violet, yellow, fluorescent colorants and the like.

The colorant may be present in the toner of the disclosure in an amount of from about 1 to about 25 percent by weight of toner, in embodiments in an amount of from about 2 to about 15 percent by weight of the toner.

Exemplary colorants include carbon black like REGAL 330® magnetites; Mobay magnetites including M08029™, MO8060™; Columbian magnetites; MAPICO BLACKS™ and surface treated magnetites; Pfizer magnetites including CB4799™, CB5300™, CB5600™, MCX6369™; Bayer magnetites including, BAYFERROX 8600™, 8610™; Northern Pigments magnetites including, NP-604™, NP-608™; Magnox magnetites including TMB-100™, or TMB-104™, HELIOGEN BLUE L6900™, D6840™, D7080™, D7020™, PYLAM OIL BLUE™, PYLAM OIL YELLOW™, PIGMENT BLUE 1™ available from Paul Uhlich and Company, Inc.; PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario; NOVAPERM YELLOW FGL™, HOSTAPERM PINK E™ from Hoechst; and CINQUASIA MAGENTA™ available from E.I. DuPont de Nemours and Company. Other colorants include 2,9-dimethyl-substituted quinacridone and anthraquinone dye identified in the Color Index as CI 60710, CI Dispersed Red 15, diazo dye identified in the Color Index as CI 26050, CI Solvent Red 19, copper tetra(octadecyl sulfonamido) phthalocyanine, x-copper phthalocyanine pigment listed in the Color Index as CI 74160, CI Pigment Blue, Anthrathrene Blue identified in the Color Index as CI 69810, Special Blue X-2137, diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33, 2,5-dimethoxy-4-sulfonanilide phenylazo-4′-chloro-2,5-dimethoxy acetoacetanilide, Yellow 180 and Permanent Yellow FGL. Organic soluble dyes having a high purity for the purpose of color gamut which may be utilized include Neopen Yellow 075, Neopen Yellow 159, Neopen Orange 252, Neopen Red 336, Neopen Red 335, Neopen Red 366, Neopen Blue 808, Neopen Black X53, Neopen Black X55, wherein the dyes are selected in various suitable amounts, for example from about 0.5 to about 20 percent by weight, in embodiments, from about 5 to about 20 weight percent of the toner.

In embodiments, colorant examples include Pigment Blue 15:3 having a Color Index Constitution Number of 74160, Magenta Pigment Red 81:3 having a Color Index Constitution Number of 45160:3, Yellow 17 having a Color Index Constitution Number of 21105, and known dyes such as food dyes, yellow, blue, green, red, magenta dyes, and the like.

The resultant blend of latex, optionally in a dispersion, and colorant dispersion may be stirred and heated to a temperature of from about 45° C. to about 65° C., in embodiments of from about 48° C. to about 63° C., resulting in toner aggregates of from about 3 microns to about 15 microns in volume average diameter, and in embodiments of from about 4 microns to about 8 microns in volume average diameter.

In embodiments, a coagulant may be added during or prior to aggregating the latex and the aqueous colorant dispersion. The coagulant may be added over a period of time from about 1 to about 20 minutes, in embodiments from about 1.25 to about 8 minutes, depending on the processing conditions.

Examples of suitable coagulants include polyaluminum halides such as polyaluminum chloride (PAC), or the corresponding bromide, fluoride, or iodide, polyaluminum silicates such as polyaluminum sulfo silicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate and the like. One suitable coagulant is PAC, which is commercially available and can be prepared by the controlled hydrolysis of aluminum chloride with sodium hydroxide. Generally, PAC can be prepared by the addition of two moles of a base to one mole of aluminum chloride. The species is soluble and stable when dissolved and stored under acidic conditions if the pH is less than about 5. The species in solution is believed to be of the formula Al₁₃O₄(OH)₂₄(H₂O)₁₂ with about 7 positive electrical charges per unit.

In embodiments, suitable coagulants include a polymetal salt such as, for example, polyaluminum chloride (PAC), polyaluminum bromide, or polyaluminum sulfosilicate. The polymetal salt can be in a solution of nitric acid, or other diluted acid solutions such as sulfuric acid, hydrochloric acid, citric acid or acetic acid. The coagulant may be added in amounts from about 0.02 to about 2 percent by weight of the toner, and in embodiments from about 0.1 to about 1.5 percent by weight of the toner.

Any aggregating agent capable of causing complexation might be used in forming toner of the present disclosure. Both alkali earth metal or transition metal salts can be utilized as aggregating agents. In embodiments, alkali (II) salts can be selected to aggregate sodio sulfonated polyester colloids with a colorant to enable the formation of a toner composite. Such salts include, for example, beryllium chloride, beryllium bromide, beryllium iodide, beryllium acetate, beryllium sulfate, magnesium chloride, magnesium bromide, magnesium iodide, magnesium acetate, magnesium sulfate, calcium chloride, calcium bromide, calcium iodide, calcium acetate, calcium sulfate, strontium chloride, strontium bromide, strontium iodide, strontium acetate, strontium sulfate, barium chloride, barium bromide, barium iodide, and optionally mixtures thereof. Examples of transition metal salts or anions which may be utilized as aggregating agent include acetates of vanadium, niobium, tantalum, chromium, molybdenum, tungsten, manganese, iron, ruthenium, cobalt, nickel, copper, zinc, cadmium or silver; acetoacetates of vanadium, niobium, tantalum, chromium, molybdenum, tungsten, manganese, iron, ruthenium, cobalt, nickel, copper, zinc, cadmium or silver; sulfates of vanadium, niobium, tantalum, chromium, molybdenum, tungsten, manganese, iron, ruthenium, cobalt, nickel, copper, zinc, cadmium or silver; and aluminum salts such as aluminum acetate, aluminum halides such as polyaluminum chloride, mixtures thereof, and the like.

Stabilizers that may be utilized in the toner formulation processes include bases such as metal hydroxides, including sodium hydroxide, potassium hydroxide, ammonium hydroxide, and optionally mixtures thereof. Also useful as a stabilizer is a composition containing sodium silicate dissolved in sodium hydroxide.

The toner may also include charge additives in effective amounts of, for example, from about 0.1 to about 10 weight percent, in embodiments from about 0.5 to about 7 weight percent. Suitable charge additives include alkyl pyridinium halides, bisulfates, the charge control additives of U.S. Pat. Nos. 3,944,493; 4,007,293; 4,079,014; 4,394,430 and 4,560,635, the entire disclosures of each of which are hereby incorporated by reference in their entirety, negative charge enhancing additives like aluminum complexes, any other charge additives, mixtures thereof, and the like.

Further optional additives which may be combined with a toner include any additive to enhance the properties of toner compositions. Included are surface additives, color enhancers, etc. Surface additives that can be added to the toner compositions after washing or drying include, for example, metal salts, metal salts of fatty acids, colloidal silicas, metal oxides, strontium titanates, mixtures thereof, and the like, which additives are each usually present in an amount of from about 0.1 to about 10 weight percent, in embodiments from about 0.5 to about 7 weight percent of the toner. Examples of such additives include, for example, those disclosed in U.S. Pat. Nos. 3,590,000, 3,720,617, 3,655,374 and 3,983,045, the disclosures of each of which are hereby incorporated by reference in their entirety. Other additives include zinc stearate and AEROSIL R972® available from Degussa. The coated silicas of U.S. Pat. Nos. 6,190,815 and U.S. Pat. No. 6,004,714, the disclosures of each of which are hereby incorporated by reference in their entirety, can also be selected in amounts, for example, of from about 0.05 to about 5 percent by weight, in embodiments from about 0.1 to about 2 percent by weight of the toner, which additives can be added during the aggregation or blended into the formed toner product.

Once the desired final size of the toner particles is achieved, the pH of the mixture may be adjusted with a base to a value of from about 5 to about 7, and in embodiments from about 6 to about 6.8. The base may include any suitable base such as, for example, alkali metal hydroxides such as, for example, sodium hydroxide, potassium hydroxide, and ammonium hydroxide. The alkali metal hydroxide may be added in amounts from about 6 to about 25 percent by weight of the mixture, in embodiments from about 10 to about 20 percent by weight of the mixture.

The mixture is subsequently coalesced. Coalescing may include stirring and heating at a temperature of from about 90° C. to about 99° C., for a period of from about 0.5 to about 12 hours, and in embodiments from about 2 to about 6 hours. Coalescing may be accelerated by additional stirring.

The pH of the mixture is then lowered to from about 3.5 to about 6 and in embodiments, to from about 3.7 to about 5.5 with, for example, an acid to coalesce the toner aggregates. Suitable acids include, for example, nitric acid, sulfuric acid, hydrochloric acid, citric acid or acetic acid. The amount of acid added may be from about 4 to about 30 percent by weight of the mixture, and in embodiments from about 5 to about 15 percent by weight of the mixture.

The mixture is cooled, washed and dried. Cooling may be at a temperature of from about 20° C. to about 40° C., in embodiments from about 22° C. to about 30° C. over a period time from about 1 hour to about 8 hours, and in embodiments from about 1.5 hours to about 5 hours.

In embodiments, cooling a coalesced toner slurry includes quenching by adding a cooling media such as, for example, ice, dry ice and the like, to effect rapid cooling to a temperature of from about 20° C. to about 40° C., and in embodiments of from about 22° C. to about 30° C. Quenching may be feasible for small quantities of toner, such as, for example, less than about 2 liters, in embodiments from about 0.1 liters to about 1.5 liters.

The toner slurry may then be washed. Washing may be carried out at a pH of from about 7 to about 12, and in embodiments at a pH of from about 9 to about 11. The washing is at a temperature of from about 45° C. to about 70° C., and in embodiments from about 50° C. to about 67° C. The washing may include filtering and reslurrying a filter cake including toner particles in deionized water. The filter cake may be washed one or more times by deionized water, or washed by a single deionized water wash at a pH of about 4 wherein the pH of the slurry is adjusted with an acid, and followed optionally by one or more deionized water washes.

Drying is typically carried out at a temperature of from about 35° C. to about 75° C., and in embodiments of from about 45° C. to about 60° C. The drying may be continued until the moisture level of the particles is below a set target of about 1% by weight, in embodiments of less than about 0.7% by weight.

As noted above, toners utilized in accordance with the present disclosure may be tailored to different sizes depending upon the pigment utilized therewith. The difference in particle size of at least one of the color toners utilized in the compositions of the present disclosure (excluding any carbon black toner) compared with the other color toners (again excluding any carbon black toner) may be in embodiments from about 10% to about 50% difference in particle size, in embodiments from about 15% to about 25% difference in particle size. The developed mass per unit area targets for the different colors is not constant, but is chosen for proper color balance at the largest possible gamut. In this way, the particle size of a given latex to be combined with a specific colorant may be chosen to optimize pigment loading, thereby providing the resulting toner with excellent color saturation, color balance and excellent mass per unit area of colorant to particle size of toner. Utilizing the processes of the present disclosure, the total run cost for the set of toners may thus be reduced compared with conventional toners utilizing particles having the same size for each color.

For example, some emulsion aggregation color toners, such as the toners used in the Xerox Copycentre C2128 (Type 1) and Xerox Phasor 7750 (Type 2) utilize three color toners in combination with a black toner. For example, the Type 1 toner includes: a black toner including a latex, a carbon black dispersion, a polyethylene wax, and polyaluminum chloride; a cyan toner including a latex, a cyan pigment dispersion, a polyethylene wax, polyaluminum chloride, and colloidal silica; a magenta toner including a latex, a magenta dispersion mixture, a polyethylene wax, polyaluminum chloride, and colloidal silica; and a yellow toner including a latex, a yellow pigment dispersion, a polyethylene wax, polyaluminum chloride, and colloidal silica. Similarly, the Type 2 toner includes: a black toner including a latex, a carbon black dispersion, a polyethylene wax, and polyaluminum chloride; a cyan toner including a latex, a cyan pigment dispersion, a polyethylene wax, and polyaluminum chloride; a magenta toner including a latex, a magenta dispersion mixture, a polyethylene wax. and polyaluminum chloride; and a yellow toner including a latex, a yellow pigment dispersion, a polyethylene wax, and polyaluminum chloride.

The magenta formulation in the 2 toners used in the Xerox Copycentre C2128 and Xerox Phasor 7750 may be both more costly and more difficult to make successfully because the pigments used for magenta are very expensive and used at relatively high loadings (about 8% total for magenta vs. about 5% for cyan and about 6% for yellow). Thus, for magenta, it may be more difficult to increase pigment levels in the toner: the pigment cost is the highest fraction of the total cost. Because of the latter, reducing particle size to lower total mass per unit area while maintaining constant pigment mass per unit area has relatively small benefits for magenta. For toners used in the Xerox Copycentre C2128 (Type 1), about a 20% size reduction for magenta would only lead to about a 14% run cost savings, whereas the cost saving for cyan and yellow would be about 17%. For the toners used in the Xerox Phasor 7750 (Type 2), which use even more expensive magenta pigments, about a 20% size reduction for magenta would only lead to about a 10% run cost savings, whereas the cost savings for cyan and yellow are about 17% to about 18% respectively. Thus, compared to the magenta, one can utilize the processes of the present disclosure to manufacture a smaller particle size toner for use with cyan and/or yellow pigments with increased pigment loading, thereby reducing costs associated with toners of those colors, rather than utilizing the same toner for all, that is, magenta, cyan and yellow.

If the size distributions are narrow for toner particles of a different size, tight distributions of the different size particles may not pose a problem. For example, some xerographic machines have different particle sizes for black toner compared to color toners. For example, in the Xerox 5765 Color Copier (commercially available from Xerox Corp.) the black toner has a volume average particle diameter of about 9.5 microns while the color toners are about 7.5 microns in diameter. Similarly, in the Xerox Docucolor 6060, the black toner has a volume average particle diameter of about 8.5 microns while the color toners are about 6.5 microns in diameter. Although the different sizes appear on the same print, transfer uniformity still occurs.

In embodiments, each of the pigments may be present in toners utilized to form a color toner of the present disclosure in an amount from about 2 to about 25 weight percent based on the weight percent of resin and pigment, wherein each of the pigments may be present in an amount of from about 2 to about 15 weight percent based on the weight percent of resin and pigment.

In embodiments a combination set, or gamut of four separate color toners, each for the development of electrostatic latent images enabling the formation of a full color gamut image may be produced, wherein the four toners include a cyan toner, a magenta toner, a yellow toner, and a black toner. The toners include the individual pigment, latex having desired particle size, and any optional additives described above. In embodiments each of the cyan, magenta, yellow and black pigments may possess a diameter particle size or agglomerate diameter size of from about 0.01 microns to about 3 microns, and wherein each of said cyan, magenta, and yellow pigments may be of a particle diameter size or agglomerate diameter size of from about 0.01 microns to about 0.3 microns, and the black pigment may be of a particle diameter size of from about 0.001 microns to about 0.1 microns.

The toner compositions generated in embodiments of the present disclosure include, for example, particles with a volume average diameter of from about 4 microns to about 7 microns, and in embodiments of from about 4.3 microns to about 6.0 microns, in an amount of from about 12% to about 25%, and in embodiments of from about 14% to about 18% by weight of the total toner composition.

In embodiments, toner utilized with a colored pigment, such as cyan, yellow, magenta, red, orange, brown, green, blue, violet, and combinations thereof, may have a particle size from about 2 microns to about 10 microns, in embodiments from about 4 microns to about 7 microns; however, as noted above, the particle size of at least one of these color toners differs from the size of at least one of the other color toners. In embodiments, a black toner may be utilized in combination with these color toners.

The toner of the present disclosure may have particles with a circularity of from about 0.93 to about 0.99, and in embodiments of from about 0.94 to about 0.98. When the spherical toner particles have a circularity in this range, the spherical toner particles remaining on the surface of the image holding member pass between the contacting portions of the imaging holding member and the contact charger, the amount of deformed toner is small, and therefore generation of toner filming can be prevented so that a stable image quality without defects can be obtained over a long period.

Toner in accordance with the present disclosure can be used in a variety of imaging devices including printers, copy machines, and the like. The toners may be used as part of an imaging process which includes the generation of an electrostatic image on a photoconductive imaging member followed by the development thereof with a combination, set, or gamut of toners, and wherein the toners may include an individual cyan toner, magenta toner, yellow toner, and black toner. While conventional color xerographic marking engines use color toners of all one size, the present disclosure allows each color toner to be different and individually optimized for the most efficient development. Toners of the present disclosure thus possess differing target masses for development.

A xerographic machine utilizing toners of the present disclosure can balance the color in spite of the differing mass targets. Toners of the present disclosure thus may result in a lower total run cost for a set of colored toners. The toners generated in accordance with the present disclosure are excellent for imaging processes, especially xerographic processes, which may operate with a toner transfer efficiency in excess of about 90 percent, such as those with a compact machine design without a cleaner or those that are designed to provide high quality colored images with excellent image resolution, acceptable signal-to-noise ratio, and image uniformity. Further, toners of the present disclosure can be selected for electrophotographic imaging and printing processes such as digital imaging systems and processes.

The imaging process includes the generation of an image in an electronic printing apparatus and thereafter developing the image with a toner composition of the present disclosure. The formation and development of images on the surface of photoconductive materials by electrostatic means is well known. The basic xerographic process involves placing a uniform electrostatic charge on a photoconductive insulating layer, exposing the layer to a light and shadow image to dissipate the charge on the areas of the layer exposed to the light and developing the resulting latent electrostatic image by depositing on the image a finely-divided electroscopic material referred to in the art as “toner”. The toner will normally be attracted to the discharged areas of the layer, thereby forming a toner image corresponding to the latent electrostatic image. This powder image may then be transferred to a support surface such as paper. The transferred image may subsequently be permanently affixed to the support surface as by heat.

Developer compositions can be prepared by mixing the toners obtained with the embodiments of the present disclosure with known carrier particles, including coated carriers, such as steel, ferrites, and the like. See, for example, U.S. Pat. Nos. 4,937,166 and 4,935,326, the disclosures of each of which are hereby incorporated by reference in their entirety. The toner-to-carrier mass ratio of such developers may be from about 2 to about 20 percent, and in embodiments from about 2.5 to about 5 percent of the developer composition. The carrier particles can include a core with a polymer coating thereover, such. as polymethylmethacrylate (PMMA), having dispersed therein a conductive component like conductive carbon black. Carrier coatings include silicone resins such as methyl silsesquioxanes, fluoropolymers such as polyvinylidiene fluoride, mixtures of resins not in close proximity in the triboelectric series such as polyvinylidiene fluoride and acrylics, thermosetting resins such as acrylics, mixtures thereof and other known components.

Development may occur via discharge area development. In discharge area development, the photoreceptor is charged and then the areas to be developed are discharged. The development fields and toner charges are such that toner is repelled by the charged areas on the photoreceptor and attracted to the discharged areas. This development process is used in laser scanners.

Development may be accomplished by the magnetic brush development process disclosed in U.S. Pat. No. 2,874,063, the disclosure of which is hereby incorporated by reference in its entirety. This method entails the carrying of a developer material containing toner of the present disclosure and magnetic carrier particles by a magnet. The magnetic field of the magnet causes alignment of the magnetic carriers in a brush like configuration, and this “magnetic brush” is brought into contact with the electrostatic image bearing surface of the photoreceptor. The toner particles are drawn from the brush to the electrostatic image by electrostatic attraction to the discharged areas of the photoreceptor, and development of the image results. In embodiments, the conductive magnetic brush process is used wherein the developer comprises conductive carrier particles and is capable of conducting an electric current between the biased magnet through the carrier particles to the photoreceptor.

Imaging methods are also envisioned with the toners disclosed herein. Such methods include, for example, some of the above patents mentioned above and U.S. Pat. Nos. 4,265,990, 4,858,884, 4,584,253 and 4,563,408, the entire disclosures of each of which are incorporated herein by reference. The imaging process includes the generation of an image in an electronic printing magnetic image character recognition apparatus and thereafter developing the image with a toner composition of the present disclosure. The formation and development of images on the surface of photoconductive materials by electrostatic means is well known. The basic xerographic process involves placing a uniform electrostatic charge on a photoconductive insulating layer, exposing the layer to a light and shadow image to dissipate the charge on the areas of the layer exposed to the light, and developing the resulting latent electrostatic image by depositing on the image a finely-divided electroscopic material, for example, toner. The toner will normally be attracted to those areas of the layer, which retain a charge, thereby forming a toner image corresponding to the latent electrostatic image. This powder image may then be transferred to a support surface such as paper. The transferred image may subsequently be permanently affixed to the support surface by heat. Instead of latent image formation by uniformly charging the photoconductive layer and then exposing the layer to a light and shadow image, one may form the latent image by directly charging the layer in image configuration. Thereafter, the powder image may be fixed to the photoconductive layer, eliminating the powder image transfer. Other suitable fixing means such as solvent or overcoating treatment may be substituted for the foregoing heat fixing step.

The following Examples are being submitted to illustrate embodiments of the present disclosure. These Examples are intended to be illustrative only and are not intended to limit the scope of the present disclosure. Also, parts and percentages are by weight unless otherwise indicated.

### EXAMPLES

### Comparative Example A

A cyan toner of volume mean size of 5.8 microns and a pigment loading of 5% Pigment Blue 15:3 was run in a Xerox Phasor 7750 printer with a magenta of volume mean size of 5.8 microns and a total pigment loading of 8.6%, a yellow toner of volume mean size of 5.8 microns and a total pigment loading of 6%, and a black toner of volume mean size of 5.8 microns and a total pigment loading of 7.5%. Pigment levels for the different process colors had been adjusted to provide optimum color saturation and color balance at the target particle size. The amount of each of the three process colors developed was adjusted to give neutral light and dark grays using the color balance software provided with the printer.

When the solid area densities on the intermediate belt were measured the average mass per unit area for each of the three process colors was 0.33 mg/cm² for yellow, 0.32 mg/cm² for magenta and 0.34 mg/cm² for cyan. These masses were equal to within the measurement error of about ±0.01 mg/cm².

### Example 1

Toner with a formulation similar to Comparative Example A was prepared, except that the size of the toner particles utilized with the different colors was varied. A cyan toner having a volume mean size of 4.6 microns and a pigment loading of 6.1% Pigment Blue 15:3 was run in a Xerox Phasor 7750 printer with a magenta of volume mean size of 5.8 microns and a total pigment loading of 8.6%, a yellow toner of volume mean size of 5.8 microns and a total pigment loading of 6%, and a black toner of volume mean size of 5.8 microns and a total pigment loading of 7.5%. Pigment levels for the different process colors had been adjusted to provide optimum color saturation and color balance at the target particle size. The amount of each of the three process colors developed was adjusted to give neutral light and dark grays using the color balance software provided with the printer. The pigment loading was 20% higher than that in Comparative Example A above and gave the same color value at a 20% lower mass per unit area.

When the solid area densities on the intermediate belt were measured the results were 0.36 mg/cm² for yellow, 0.35 mg/cm² for magenta and 0.28 mg/cm² for cyan. The cyan mass per unit area is 20% lower than the other process colors. The print quality generated by the toners of Example 1 was equivalent to that of Comparative Example A. Thus the pigment level of the cyan were raised, the size of the toner correspondingly decreased, and the mass per unit area decreased while retaining gray balance and print quality.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A composition comprising:
a first toner comprising a first resin in combination with a first colorant; and
a second toner comprising a second resin in combination with a second colorant;
wherein the first colorant and the second colorant are different and are not carbon black and wherein particles comprising the first toner differ in volume average diameter from particles comprising the second toner by from about 10% to about 50% in size.

2. The composition of claim 1, wherein the first resin and the second resin are the same or different and are selected from the group consisting of styrenes, acrylates, methacrylates, butadienes, isoprenes, acrylic acids, methacrylic acids, acrylonitriles, and mixtures thereof.

3. The composition of claim 1, wherein the first resin and the second resin are the same or different and are selected from the group consisting of poly(styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylateisoprene), poly(methyl acrylate-isoprene), poly(ethyl acrylate-isoprene), poly(propyl acrylate-isoprene), poly(butyl acrylate-isoprene), poly(styrene-butylacrylate), poly(styrene-butadiene), poly(styrene-isoprene), poly(styrene-butyl methacrylate), poly(styrene-butyl acrylate-acrylic acid), poly(styrene-butadiene-acrylic acid), poly(styrene-isoprene-acrylic acid), poly(styrene-butyl methacrylate-acrylic acid), poly(butyl methacrylate-butyl acrylate), poly(butyl methacrylate-acrylic acid), poly(styrene-butyl acrylate-acrylonitrile-acrylic acid), and poly(acrylonitrile-butyl acrylate-acrylic acid).

4. The composition of claim 1, wherein the first colorant and the second colorant are selected from the group consisting of pigments, dyes, mixtures of pigments and dyes, mixtures of pigments, and mixtures of dyes.

5. The composition of claim 1, wherein the first colorant and the second colorant are selected from the group consisting of cyan, yellow, magenta, red, orange, brown, green, blue, violet and combinations thereof.

6. The composition of claim 1, wherein the size of particles comprising the first toner differ in volume average diameter from particles comprising the second toner by from about 15% to about 25% in size.

7. A color toner comprising the composition of claim 1, wherein the first toner and the second toner are optionally in combination with one or more components selected from the group consisting of surfactants, coagulants, waxes, surface additives, and optionally mixtures thereof.

8. The color toner of claim 7, wherein the first toner and the second toner comprise an emulsion aggregation toner.

9. The composition of claim 1, further comprising at least one additional toner comprising at least one resin in combination with at least one different colorant, wherein the at least one different colorant is selected from the group consisting of carbon black, cyan, yellow, magenta, red, orange, brown, green, blue, violet and combinations thereof.

10. The composition of claim 9,wherein the composition includes two additional toners comprising two resins in combination with two different colorants.

11. A composition comprising:
a cyan toner comprising a first resin in combination with a first colorant;
a magenta toner comprising a second resin in combination with a second colorant;
a yellow toner comprising a third resin in combination with a third colorant; and
a carbon black toner comprising a fourth resin in combination with a fourth colorant,
wherein particles comprising one of the cyan, magenta, or yellow toners differ in volume average diameter from particles comprising the other toners not including carbon black by from about 10% to about 50% in size.

12. The composition of claim 11, wherein the first resin, the second resin, the third resin, and the fourth resin are the same or different and are selected from the group consisting of styrenes, acrylates, methacrylates, butadienes, isoprenes, acrylic acids, methacrylic acids, acrylonitriles, and mixtures thereof.

13. The composition of claim 11, wherein the first resin, the second resin, the third resin, and the fourth resin are the same or different and are selected from the group consisting of poly(styrene-butadiene), poly(methyl methacrylate-butadiene), poly(ethyl methacrylate-butadiene), poly(propyl methacrylate-butadiene), poly(butyl methacrylate- butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate- isoprene), poly(ethyl methacrylate-isoprene), poly(propyl methacrylate-isoprene), poly(butyl methacrylateisoprene), poly(methyl acrylate-isoprene), poly(ethyl acrylate-isoprene), poly(propyl acrylate-isoprene), poly(butyl acrylate-isoprene), poly(styrene-butylacrylate), poly(styrene-butadiene), poly(styrene-isoprene), poly(styrene-butyl methacrylate), poly(styrene-butyl acrylate-acrylic acid), poly(styrene-butadiene-acrylic acid), poly(styrene-isoprene-acrylic acid), poly(styrene-butyl methacrylate-acrylic acid), poly(butyl methacrylate-butyl acrylate), poly(butyl methacrylate-acrylic acid), poly(styrene-butyl acrylate-acrylonitrile-acrylic acid), and poly(acrylonitrile-butyl acrylate-acrylic acid).

14. The composition of claim 11, wherein the first resin, the second resin, the third resin, and the fourth resin are the same or different and are prepared by emulsion aggregation methods.

15. The composition of claim 11, wherein the first colorant, the second colorant, the third colorant and the fourth colorant are different and are selected from the group consisting of pigments, dyes, mixtures of pigments and dyes, mixtures of pigments, and mixtures of dyes, and wherein the size of particles comprising one of the color toners other than carbon black differ in volume average diameter from particles comprising at least one of the other color toners other than carbon black by from about 15% to about 25% in size.

16. The composition of claim 11, further comprising at least one additional toner comprising a resin in combination with a colorant selected from the group consisting of red, orange, brown, green, blue, violet, and combinations thereof.

17. A process comprising:
contacting a first resin with a first colorant to form a first toner;
contacting a second resin with a second colorant to form a second toner; and
contacting the first toner with the second toner to form a color toner,
wherein the first colorant and the second colorant are different and are not carbon black and wherein particles comprising the first toner differ in volume average diameter from particles comprising the second toner by from about 10% to about 50%.

18. The process of claim 17, wherein the first resin and the second resin are the same or different and are selected from the group consisting of styrenes, acrylates, methacrylates, butadienes, isoprenes, acrylic acids, methacrylic acids, acrylonitriles, and mixtures thereof, and the first colorant and the second colorant are different and are selected from the group consisting of pigments, dyes, mixtures of pigments and dyes, mixtures of pigments, and mixtures of dyes.

19. The process of claim 17, wherein the first resin and the second resin are the same or different and are selected from the group consisting of poly(styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylateisoprene), poly(methyl acrylate-isoprene), poly(ethyl acrylate-isoprene), poly(propyl acrylate-isoprene), poly(butyl acrylate-isoprene), poly(styrene-butylacrylate), poly(styrene-butadiene), poly(styrene-isoprene), poly(styrene-butyl methacrylate), poly(styrene-butyl acrylate-acrylic acid), poly(styrene-butadiene-acrylic acid), poly(styrene-isoprene-acrylic acid), poly(styrene-butyl methacrylate-acrylic acid), poly(butyl methacrylate-butyl acrylate), poly(butyl methacrylate-acrylic acid), poly(styrene-butyl acrylate-acrylonitrile-acrylic acid), and poly(acrylonitrile-butyl acrylate-acrylic acid), and wherein the first colorant and the second colorant are different and are selected from the group consisting of cyan, yellow, magenta, red, orange, brown, green, blue, violet and combinations thereof.

20. The process of claim 17, wherein the size of particles comprising the first toner differ in volume average diameter from particles comprising the second toner by from about 15% to about 25%, optionally further comprising contacting the first toner and the second toner with one or more components selected from the group consisting of surfactants, coagulants, waxes, surface additives, and optionally mixtures thereof, and optionally further comprising contacting the first toner and second toner with at least one additional toner comprising at least one resin in combination with at least one different colorant, wherein the at least one different colorant is selected from the group consisting of carbon black, cyan, yellow, magenta, red, orange, brown, green, blue, violet and combinations thereof.
